(19) United States
(12) Patent Application Publication
(10) Pub. No.: US 2013/0077120 A1
(43) Pub. Date: Mar. 28, 2013

(54) MEDIA PROCESSING DEVICE AND METHOD OF CONTROLLING A MEDIA PROCESSING DEVICE

(71) Applicant: Satoshi Miyazawa, Ueda-shi (JP)

(72) Inventor: Satoshi Miyazawa, Ueda-shi (JP)

(73) Assignee: Seiko Epson Corporation, Tokyo (JP)

(21) Appl. No.: 13/616,578

(22) Filed: Sep. 14, 2012

(30) Foreign Application Priority Data
Sep. 27, 2011 (JP) 2011-210852
Jul. 27, 2012 (JP) 2012-167182

(51) Int. Cl. G06F 15/00

(52) U.S. Cl. 358/1.13

(57) ABSTRACT

A media processing device that processes plural types of process media, and a method of controlling the media processing device, reduce the delay when switching the medium to be processed. The media processing device has a first process unit that executes an operation related to processing a medium; a second process unit that executes an operation related to processing a different medium than the first process unit; and a CPU that changes the control object to the first process unit according to a selection command instructing switching from the second process unit to the first process unit, and applies control to not initialize the first process unit if it was already initialized.

The entire disclosure of Japanese Patent Application Nos: 2011-210852, filed Sep. 27, 2011 and 2012-167182, filed Jul. 27, 2012 are expressly incorporated by reference herein.

### BACKGROUND

1. Technical Field

The present invention relates to a media processing device and a method of controlling a media processing device.

2. Related Art

Printers and other media processing devices that process media such as printing paper, and have plural printing devices or other process units for processing plural different types of process media, are known from the literature. See, for example, Japanese Unexamined Patent Appl. Pub. JP-A-2010-137566. This type of media processing device selects the medium to process and operates the appropriate process unit to process the medium as controlled by an external computer, for example.

Initialization is required when a device with mechanical mechanisms starts operating to confirm whether or not each unit containing a mechanical mechanism operates normally. This initialization process operates each mechanical mechanism to check if the mechanism actually works as expected, and initialization can therefore be relatively time-consuming. Performing other control operations during initialization is also usually not possible. Minimizing the number of times initialization is performed is therefore desirable.

### SUMMARY

The present invention therefore minimizes the number of times that mechanisms used to process media are initialized in a device that processes media. By suppressing the number of times initialization is performed, the invention also reduces how long the user must wait to use the device.

One aspect of the invention is a media processing device having a first process unit that executes an operation related to processing a medium; a second process unit that executes an operation related to processing the same medium or a different medium; and a switching control unit that changes the control object to the second process unit according to a selection command instructing switching from the first process unit to the second process unit, and applies control to not initialize the second process unit if the second process unit was already initialized.

This aspect of the invention can eliminate unnecessary initialization and reduce the number of initializations when changing the process unit to be controlled according to the selection command because the process unit being selected is not initialized again if it has already been initialized. The delay time accompanying changing the controlled process unit can also be shortened by suppressing the number of initializations performed.

The media processing device according to another aspect of the invention initializes the second process unit when a command related to the second process unit is received if the second process unit was not already initialized when the selection command was received.

If the second process unit that is selected when the selection command is received has not been initialized, the second process unit is initialized when a command related to the second process unit is received. Unnecessary initializations can therefore be eliminated when, for example, a selection command to select another process unit is received before the second process unit is used after being selected by receiving a first selection command. The delay time accompanying the initialization process can therefore be reduced. Use of consumables can also be reduced in configurations that spend consumables in conjunction with the initialization process, such as by cleaning the printhead in an inkjet printing device, by reducing the number of times initialization is performed unnecessarily.

The media processing device according to another aspect of the invention preferably also has a storage unit that stores information related to the second process unit; and the switching control unit determines whether or not to initialize the second process unit based on the information related to the second process unit stored in the storage unit.

This aspect of the invention can appropriately determine if initialization is needed by referencing information related to the second process unit that is selected to operate.

When the second process unit is initialized, the switching control unit in a media processing device according to another aspect of the invention preferably also stores a history of initializing the second process unit in the storage unit as the information related to the second process unit.

By storing a record of having initialized the process unit when the selected process unit is initialized, this aspect of the invention can appropriately determine if initialization is needed based on the initialization history.

In a media processing device according to another aspect of the invention, the information related to the second process unit stored in the storage unit is the time elapsed since the second process unit was initialized; and the switching control unit determines whether or not to initialize the second process unit based on the elapsed time stored in the storage unit.

This aspect of the invention can appropriately determine if initialization is needed based on the time past since initialization.

In a media processing device according to another aspect of the invention, the information related to the second process unit stored in the storage unit is an error history that is stored when an error occurs in the second process unit; and the switching control unit determines whether or not to initialize the second process unit based on the error history stored in the storage unit.

This aspect of the invention can appropriately determine if initialization is needed based on the history of errors that occurred in the process unit.

In a media processing device according to another aspect of the invention, the second process unit has a mechanical mechanism or a control circuit; and initialization of the second process unit includes initialization of the mechanical mechanism or initialization of the control circuit.

This aspect of the invention can initialize the mechanical mechanism or control circuit when necessary, eliminate unnecessary initialization, and reduce the delay accompanying initialization. Examples of initialization of a mechanical mechanism include cleaning an inkjet head, detecting if media is present, and conveying media to eliminate backlash in the media conveyance mechanism, and examples of control circuit initialization include clearing memory, writing settings to memory, and reading or writing circuit data for FPGA and other programmable logic circuits.

In another aspect of the invention, the first process unit is a print unit that prints on roll media; and the second process unit is a reading unit that reads information recorded on sheet media.

Another aspect of the invention is a method of controlling a media processing device, including steps of: receiving a selection command to change from a first process unit that executes an operation related to processing a medium to a second process unit that executes an operation related to processing the same medium or a different medium; determining if the second process unit has been initialized when changing to the second process unit based on the received selection command; and not initializing the second process unit based on the selection command if the second process unit was already initialized.

This aspect of the invention can eliminate unnecessary initialization and reduce the number of initializations when changing the process unit to be controlled according to the selection command because the process unit being selected is not initialized again if it has already been initialized. The delay time accompanying changing the controlled process unit can also be shortened by suppressing the number of initializations performed.

A method of controlling a media processing device according to another aspect of the invention also has a step of: initializing the second process unit when a command related to the second process unit is received if the second process unit was not already initialized when the selection command was received.

A method of controlling a media processing device according to another aspect of the invention also has a step of determining whether or not the second process unit has been initialized based on information related to the second process unit stored in a storage unit when changing to the second process unit based on a received selection command.

A method of controlling a media processing device according to another aspect of the invention also has a step of storing a history of initializing the second process unit in the storage unit as the information related to the second process unit when the second process unit is initialized.

A method of controlling a media processing device according to another aspect of the invention also has a step of storing the time elapsed since the second process unit was initialized as the information related to the second process unit in the storage unit.

A method of controlling a media processing device according to another aspect of the invention also has a step of storing an error history that is stored when an error occurs in the second process unit as the information related to the second process unit in the storage unit.

The invention enables eliminating unnecessary initialization operations, reducing the number of initializations performed, and reducing the delay time accompanying initialization when changing the process unit selected for control.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an oblique view of a media processing device according to a preferred embodiment of the invention.

FIG. 2 is a plan view of the media processing device.

FIG. 3 is a block diagram of a media processing system.

FIG. 4 is a flow chart of the operation of the media processing device.

FIG. 5 is a flow chart of the operation of the media processing device.

### DESCRIPTION OF EMBODIMENTS

A preferred embodiment of the present invention is described below with reference to the accompanying figures.

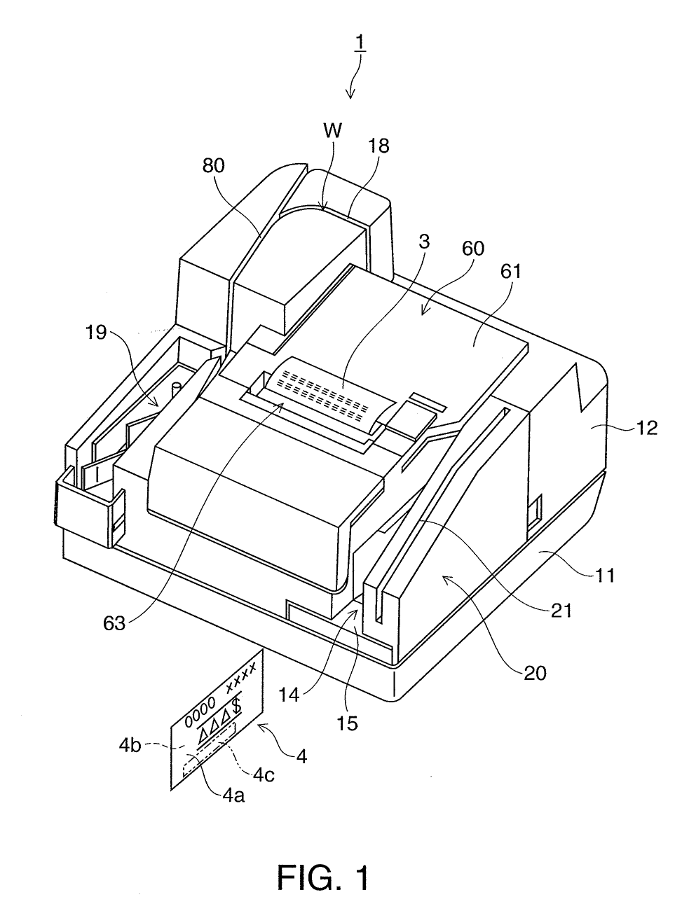

FIG. 1 is an oblique view of a media processing device 1 according to this embodiment of the invention.

As shown in FIG. 1, the media processing device 1 is a device that can process media such as checks and other forms (referred to herein as “processed media”) in multiple ways, including reading magnetic ink characters printed on the processed medium, optically imaging (scanning) both sides of the processed medium, and recording (printing) images including text on the processed medium. The media processing device 1 also functions as a card reader that reads magnetic information recorded on card media such as credit cards, and functions to produce specific types of tickets with an image recorded thereon by recording an image to thermal roll paper 3 and cutting the paper.

This embodiment of the invention describes processing checks 4 and roll paper 3 as examples of processed media.

As shown in FIG. 1, a check 4 is a form having a payment amount, payee, serial number, payer signature, and other information printed on a sheet (paper) with a specific colored or patterned background. The payment amount, payee, serial number, payer signature, and other information are printed on the face 4a, and an endorsement area is provided on the back 4b. An endorsement is printed with specific text or an image in the endorsement area by the inkjet head 10 described below. An MICR (magnetic ink character recognition) line 4c is preprinted along the length of the check 4 on the face 4a. The MICR line 4c is a line of magnetic ink characters printed with magnetic ink, and can be read magnetically and optically.

The roll paper 3 is thermal paper that changes color when heat is applied, and the media processing device 1 records text and images by applying heat to the recording side of the roll paper 3 with a thermal printer unit 60.

The outside case of the media processing device 1 includes a bottom case 11 that covers the bottom part of the media processing device 1, and a cover 12 that covers the bottom case 11, and the main unit of the media processing device 1 is housed inside this outside case. An entrance 14 for inserting checks 4 is open at the front of the media processing device 1, and a stacker 15 that can hold a stack of plural checks 4 is provided inside the entrance 14. The stacker 15 can be pulled out to the front, and the checks 4 can be loaded into the stacker 15 after adjusting the stacker 15 to the size of the checks 4 to be stored in the stacker 15.

A slot 18 that is substantially U-shaped when seen from above and is used as the conveyance path W of the checks 4 is formed in the cover 12, and the slot 18 ends in an exit pocket 19 at the front of the media processing device 1. Checks 4 stored in the stacker 15 are fed one by one into the media processing device 1 as described below, are processed as they pass through the slot 18, and the processed checks 4 are discharged into the exit pocket 19. Multiple checks 4 can accumulate in the exit pocket 19.

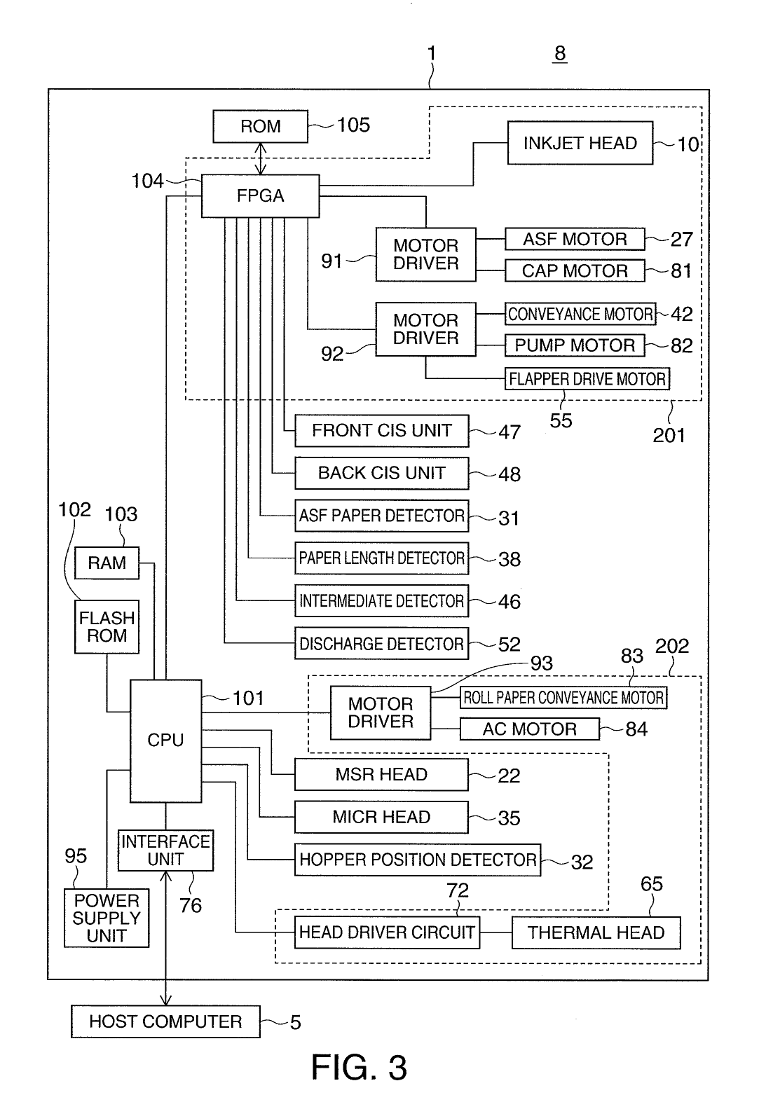

As shown in FIG. 1, a magnetic card reader 20 is disposed beside the stacker 15. The magnetic card reader 20 includes a card slot 21 formed in the cover 12, and a MSR (magnetic stripe reader) head 22 (FIG. 3) disposed facing the card slot 21, and reads information magnetically recorded on cards passing through the card slot 21 with the MSR head 22.

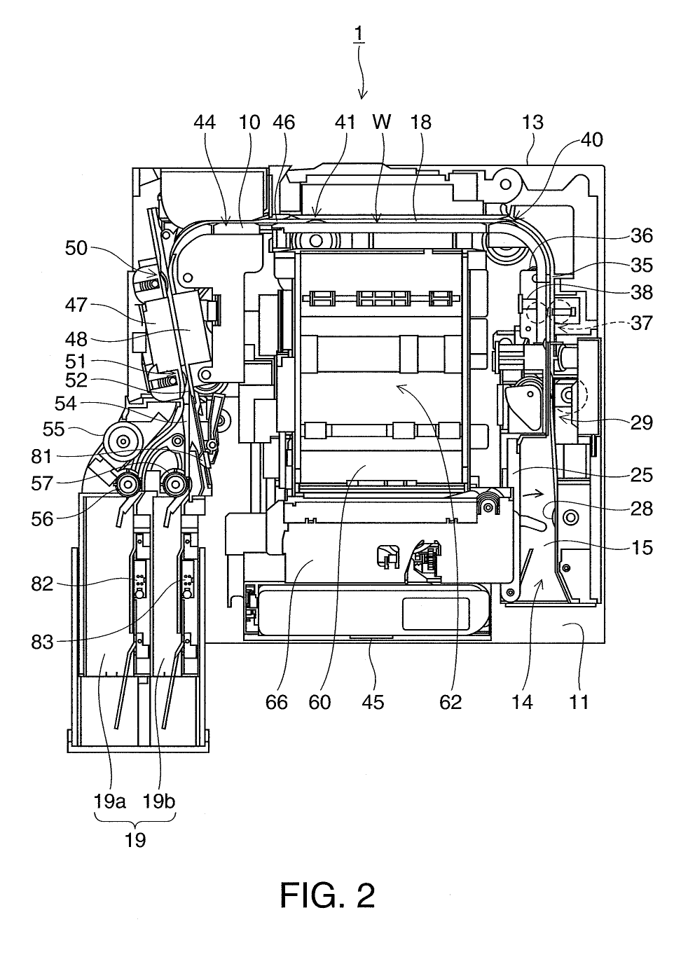

FIG. 2 is a plan view showing the configuration of the main unit of the media processing device 1 housed the outside case. As shown in FIG. 2, a hopper 25 is disposed on one side of the stacker 15. The hopper 25 can pivot in the direction of the arrow, is moved by power from an ASF motor 27, and urges the checks 4 in the stacker 15 to the other side.

A pickup roller 28 driven by an ASF (automatic [sic] sheet feeder) motor 27 (FIG. 3) described below is disposed on the other side of the stacker 15, and when the hopper 25 rotates toward the pickup roller 28, one check 4 in the stacker 15 is urged by the rotating hopper 25 to the pickup roller 28, contacts the roller, and is fed into the conveyance path W by rotation of the pickup roller 28.

An ASF roller set 29 composed of a pair of rollers is disposed downstream from the stacker 15. The two rollers of the ASF roller set 29 are disposed on opposite sides of the conveyance path W, one roller is driven by the ASF motor 27, and the other roller is a follower roller. The check 4 in contact with the pickup roller 28 is nipped by the ASF roller set 29, and conveyed downstream through the slot 18.

An ASF paper detector 31 (FIG. 3) is disposed to a specific position in the stacker 15. The ASF paper detector 31 is a transmissive photosensor in this embodiment, and detects if a check 4 is in the stacker 15.

A hopper position detector 32 (FIG. 3) is disposed at the standby position of the hopper 25 in the stacker 15. The hopper position detector 32 is a transmissive photosensor in this embodiment, and detects if the hopper 25 is in the standby position.

A MICR (magnetic ink character recognition) head 35 that contacts the face 4a of the check 4 and magnetically reads the MICR line 4c (FIG. 1) is disposed downstream from the ASF roller set 29. A MICR roller 36 is disposed opposite the MICR head 35. The MICR roller 36 is urged to the MICR head 35 side, rotates while pressing the check 4 against the MICR head 35, and conveys checks 4 at a constant speed suited to reading the MICR line. An assist roller set 37 composed of a pair of rollers that guide the check 4 fed by the ASF roller set 29 to the MICR head 35 is disposed on the upstream side of the MICR head 35.

A paper length detector 38 is disposed to the conveyance path W between the assist roller set 37 and MICR head 35. The paper length detector 38 is a reflective photosensor in this embodiment, and detects the leading end and trailing end of each check 4 by detecting if a check 4 passing through the conveyance path W is at the detection position. The control unit 70 acquires the output signals of the paper length detector 38 and determines the length of the check 4 based on change in detector output.

A first conveyance roller set 40 including a pair of rollers disposed on opposite sides of the conveyance path W is disposed to the conveyance path W on the downstream side of the MICR head 35, and a second conveyance roller set 41 is disposed downstream from the first conveyance roller set 40. The first conveyance roller set 40 and second conveyance roller set 41 are driven rotationally by a conveyance motor 42 (FIG. 3), and these rollers convey the check 4 to the inkjet printer unit 44 (print means).

The inkjet printer unit 44 has an inkjet head 10 (inkjet recording head). The inkjet head 10 is an inkjet recording head that is supplied with ink from an ink cartridge 45 (ink storage unit) installed in the front part of the media processing device 1 and ejects ink onto the check 4. The inkjet head 10 in this embodiment prints an endorsement including text or symbols on the back 4b of the check 4.

A cap (not shown in the figure) is disposed in front of the inkjet head 10 with the conveyance path W therebetween. The cap can move to and away from the inkjet head 10 side as driven by a cap motor 81 (FIG. 3), and advances to the inkjet head 10 side and covers the nozzle face of the inkjet head 10 when a check 4 is not being processed to prevent the ink from drying. A hole for suctioning ink is disposed inside the cap, and this hole communicates with a suction pump not shown.

The suction pump is driven by a pump motor 82 (FIG. 3), and suctions ink from the nozzles of the inkjet head 10 through the cap when a cleaning operation that solves ejection problems in the nozzles of the inkjet head 10 is performed. Ink removed by the suction pump is stored in a waste ink tank (not shown in the figure).

An intermediate detector 46 is disposed between the inkjet head 10 and second conveyance roller set 41. The intermediate detector 46 is a reflective photosensor in this embodiment, and detects if a check 4 is at the detection position.

A CIS (contact image sensor) unit for optically reading checks 4 is disposed downstream from the inkjet head 10. This CIS unit includes a front CIS unit 47 for imaging the face 4a of the check 4, and a back CIS unit 48 for imaging the back 4b, and can thus optically image both sides of each check 4. The front CIS unit 47 and back CIS unit 48 are disposed on opposite sides of the conveyance path W. A first CIS roller 50 is disposed on the upstream side and a second CIS roller 51 is disposed on the downstream side of these units. The first CIS roller 50 and second CIS roller 51 are rollers that are driven rotationally by the conveyance motor 42, and checks 4 are conveyed by these rollers at a constant speed while being imaged by the CIS units.

A discharge detector 52 is located downstream from the second CIS roller 51. The discharge detector 52 is a reflective photosensor in this embodiment, and detects if a check 4 is at the detection position.

The exit pocket 19 described above is located downstream from the front CIS unit 47 and back CIS unit 48. The exit pocket 19 is divided into a main pocket 19a and a sub-pocket 19b, and the slot 18 splits and is connected to both the main pocket 19a and sub-pocket 19b. The main pocket 19a and sub-pocket 19b can each hold a plurality of checks 4.

A flapper 54 that switches the exit pocket 19 into which the check 4 is discharged to the main pocket 19a or sub-pocket 19b is disposed at the position where the slot 18 splits. The flapper 54 is a guide that by closing the path to the main pocket 19a or the path to the sub-pocket 19b guides the check 4 into the other pocket, and is driven by the flapper drive motor 55.

A discharge roller 56 is disposed to the path from the flapper 54 to the main pocket 19a, another discharge roller 57 is disposed to the path from the flapper 54 to the sub-pocket 19b, and the checks 4 are thus smoothly discharged by these rollers and guided by the flapper 54 into the appropriate exit pocket 19.

As described below, the media processing device 1 discharges the check 4 into the main pocket 19a when the check 4 is determined to have been correctly loaded based on the result of the MICR head 35 reading the MICR line 4c, and into the sub-pocket 19b when the check 4 is determined to have not been correctly loaded.

As shown in FIG. 1 and FIG. 2, a thermal printer unit 60 (print means) is disposed in the middle of the media processing device 1.

A shown in FIG. 1, the thermal printer unit 60 has a printer cover 61 covering the top of the media processing device 1. This printer cover 61 is attached to the cover 12 so that the printer cover 61 can open and close freely. When the printer cover 61 is open, a roll paper compartment 62, which is a space for holding roll paper 3, is exposed and the roll paper 3 can be installed or replaced. A paper exit 63 is formed in the printer cover 61, and the roll paper 3 held in the roll paper compartment 62 can be discharged through the paper exit 63.

The thermal printer unit 60 includes a roller platen (not shown in the figure) that supplies and feeds roll paper 3 stored in the roll paper compartment 62, a thermal head 65 (FIG. 3) disposed opposite the platen, and a cutter unit 66 that cuts the roll paper 3 perpendicularly to the conveyance direction. To produce a ticket, the platen of the thermal printer unit 60 is driven rotationally by power from the roll paper conveyance motor 83 (FIG. 3) and conveys the roll paper 3 in the conveyance direction. The cutter unit 66 has a movable knife (not shown in the figure) that operates with power from the AC (auto cutter) motor 84, and a fixed knife (not shown in the figure), and cuts the roll paper 3 by the cutting action of the movable knife and fixed knife with the roll paper 3 therebetween. The thermal printer unit 60 records characters and images on the roll paper 3 with the thermal head 65 while rotating the platen and conveying the roll paper 3, and then cuts the roll paper 3 at a specific position with the cutter unit 66, producing a ticket. This ticket is a transaction record (receipt) related to a transaction using a check 4, for example.

FIG. 3 is a block diagram showing the functional configuration of a media processing system 8 composed of the media processing device 1 connected to a host computer 5.

As shown in FIG. 3, the media processing device 1 has a CPU 101 and a FPGA 104 as control devices that control the media processing device 1. The CPU 101 reads and writes a program stored in flash ROM 102 to RAM 103, and controls parts of the media processing device 1 including the FPGA 104. The FPGA 104 is a programmable device that performs the operations set in a programming file stored in ROM 105, and controls other parts as described below.

The media processing device 1 also has a power supply unit 95 that converts an externally supplied voltage and supplies power to the parts of the media processing device 1. The power supply unit 95 has a function that changes the supply state of the power supply to other parts of the media processing device 1 as controlled by the CPU 101. For example, the CPU 101 controls supplying power from the power supply unit 95 to the motor drivers 91, 92, 93, and controls supplying power to motors including the ASF motor 27, cap motor 81, conveyance motor 42, pump motor 82, flapper drive motor 55, roll paper conveyance motor 83, and AC motor 84 to not exceed the power supply capacity of the power supply unit 95. The CPU 101 also executes a power conservation control process (power supply control process) described below and switches the power supply from the power supply unit 95 to other parts on/off based on the operating state of the media processing device 1 to suppress power consumption when the media processing device 1 is idle.

Connected to the CPU 101 are flash ROM 102 that stores programs run by the CPU 101 and data related to the programs, and RAM 103 that temporarily stores the programs run by the CPU 101 and related data.

ROM 105 that stores the programming file (configuration data) of the FPGA 104 is connected to the FPGA 104.

The FPGA 104 runs a configuration process when power supply from the power supply unit 95 starts.

This configuration process includes the following steps, and is executed every time the power supply from the power supply unit 95 to the FPGA 104 switches from off to on.
Checking the power supply voltage from the power supply unit 95
Running an initialization process including clearing internal memory
Detecting the programming file stored in ROM 105
Loading the detected programming file from ROM 105
Writing circuit data according to the loaded programming file

The inkjet head 10 is connected to the FPGA 104. The CPU 101 writes a print image of the text and images to be printed to RAM 103 according to a command from the host computer 5, and generates and outputs data for ejecting ink from the nozzles of the inkjet head 10 based on the print image to the FPGA 104. The FPGA 104 operates the inkjet head 10 based on the ink ejection data input from the CPU 101, and ejects ink from the inkjet head 10 onto the check 4 to print.

Motor drivers 91, 92 are connected to the FPGA 104, and the FPGA 104 controls the motor drivers 91, 92 based on control data input from the CPU 101. The motor driver 91 is connected to the ASF motor 27 and cap motor 81, supplies drive current to the ASF motor 27 and cap motor 81 as controlled by the FPGA 104, and drives the motors in the direction, speed, and amount specified by the FPGA 104. The other motor driver 92 supplies drive current to the conveyance motor 42 that drives the rollers that convey the checks 4, and to the pump motor 82 and flapper drive motor 55, and drives the motors in the direction, speed, and amount specified by the FPGA 104.

The front CIS unit 47 and back CIS unit 48 are connected to the FPGA 104.

The FPGA 104 images the face 4a and back 4b of the check 4 with the front CIS unit 47 and back CIS unit 48 according to control data input from the CPU 101. The FPGA 104 then digitizes the signals output from the front CIS unit 47 and back CIS unit 48, and outputs the digitized data to the CPU 101.

Detectors including the ASF paper detector 31, paper length detector 38, and intermediate detector 46 are also connected to the FPGA 104. The FPGA 104 outputs detection pulses to the ASF paper detector 31, paper length detector 38, and intermediate detector 46, and acquires output signals from the detectors at specific periods.

The FPGA 104 digitizes the output values acquired from the detectors, determines if a check 4 is in the stacker 15, if a check 4 is detected by the paper length detector 38, and if a check 4 is detected by the intermediate detector 46 by comparing the digitized detector values with predetermined threshold values for each detector, and stores the results in an internal register (not shown). The CPU 101 reads the detection result data for each detector stored in the register of the FPGA 104 at specific times.

Motor driver 93 is connected to the CPU 101. The motor driver 93 supplies drive current to the roll paper conveyance motor 83 that drives the platen to convey the roll paper 3, and the AC motor 84 that operates the movable knife (not shown in the figure) of the cutter unit 66, and drives these motors in the direction, speed, and amount specified by the CPU 101.

The MSR head 22 and MICR head 35 are connected to the CPU 101. The CPU 101 causes the MSR head 22 to read the magnetic information when a card is swiped through the card slot 21 (FIG. 1), and detects the read signal output from the MSR head 22.

The CPU 101 also reads magnetic information recorded on a check 4 with the MICR head 35, and detects the output signal from the MICR head 35.

The hopper position detector 32 is also connected to the CPU 101, and the CPU 101 determines if the hopper 25 is in the standby position by outputting a detection pulse to the hopper position detector 32 and getting the output signal from the hopper position detector 32.

The head driver circuit 72 that drives the thermal head 65 is also connected to the CPU 101. The head driver circuit 72 controls energizing the heat elements of the thermal head 65 and prints characters and images on the roll paper 3 with the thermal head 65 as controlled by the CPU 101.

An interface unit 76 that is connected to the host computer 5 by wire or wirelessly is also connected to the CPU 101. The CPU 101 controls the interface unit 76 to exchange data, including control data, with the host computer 5. The CPU 101 tries receiving a command sent from the host computer 5 at a regular period with the interface unit 76 so that commands sent from the host computer 5 can be quickly received.

The CPU 101 receives a process control command sent from the host computer 5 and processes a check 4 accordingly.

The CPU 101 determines if a check 4 is in the stacker 15 based on the result of evaluating the output of the ASF paper detector 31 according to the check 4 processing command. If a check 4 is in the stacker 15, the CPU 101 checks if the hopper 25 is in the standby position based on the output of the hopper position detector 32, operates the ASF motor 27 through the FPGA 104, and picks and feeds one check 4 into the conveyance path W.

Next, the CPU 101 controls the FPGA 104 to operate the conveyance motor 42, operates the ASF roller set 29, MICR roller 36, assist roller set 37, first conveyance roller set 40, second conveyance roller set 41, first CIS roller 50, second CIS roller 51, and discharge rollers 56, 57, and conveys the check 4.

The CPU 101 also controls the FPGA 104 to operate the flapper drive motor 55 and move the flapper 54 and set the output pocket of the processed check 4 to the main pocket 19a or sub-pocket 19b, and discharge the check 4 with the discharge rollers 56, 57.

The roll paper conveyance motor 83, AC motor 84, and motor driver 93 that operate as controlled by the CPU 101 function as a conveyance means for the roll paper 3. The ASF motor 27, conveyance motor 42, and motor drivers 91, 92 that operate as controlled by the FPGA 104 also function as a conveyance means for checks 4.

The CPU 101 reads with the MSR head 22 according to a command to read the MICR line 4c of the check 4, acquires and recognizes the magnetic waveform or data output from the MSR head 22, and outputs the recognition result to the host computer 5.

Based on a command for printing a check 4 and the print data sent with the print command, the CPU 101 generates a print image of the text and images to be recorded, and prints the text and images in the print image on the face 4a or back 4b of the check 4 with the inkjet head 10 by controlling the FPGA 104.

The CPU 101 also controls the FPGA 104 according to a command for optically scanning the check 4 to read the face 4a and back 4b of the check 4 with the front CIS unit 47 and back CIS unit 48, and outputs the captured image data input from the FPGA 104 to the host computer 5.

If a command to print on the roll paper 3 is received from the host computer 5, CPU 101 generates and buffers a print image of the text and images to be recorded. The CPU 101 then controls the motor driver 93 to drive the roll paper conveyance motor 83 and convey the roll paper 3 with the platen, and controls the head driver circuit 72 to print text and images based on the print image to the roll paper 3 with the thermal head 65. After printing, the CPU 101 operates the AC motor 84 with the motor driver 93, and cuts the roll paper 3 with the cutter unit 66.

The CPU 101 controls switching between the motor drivers 91, 92, 93 connected to the power supply unit 95 based on whether the media processing device 1 is to process roll paper 3 or process a check 4 based on the command received from the host computer 5. Depending upon the specifications of the power supply unit 95, operating the plural motors driven by the motor drivers 91, 92, 93 of the media processing device 1 simultaneously could exceed the rated capacity of the power supply unit 95, for example. If the power supply unit 95 is connected to all of the motor drivers 91, 92, 93 in this case, the motors connected to each of the drivers could operate at the same time and the load could exceed the rated capacity.

The CPU 101 therefore controls appropriately switching between the motor drivers connected to the power supply unit 95 according to the amount of power that the power supply unit 95 can supply.

The media processing device 1 according to this embodiment of the invention groups the motor drivers 91, 92, 93 and the motors connected thereto into a process unit 201 that performs operations related to checks 4, and a process unit 202 that performs operations related to roll paper 3. The process units 201 and 202 function as process units in the accompanying claims.

Process unit 201 includes the inkjet head 10, motor drivers 91, 92, and the ASF motor 27, cap motor 81, conveyance motor 42, pump motor 82, and flapper drive motor 55 connected thereto. The front CIS unit 47, back CIS unit 48, and MICR head 35 could also be included in the process unit 201 as process units that process checks 4.

The process unit 202 that processes roll paper 3 includes the head driver circuit 72, thermal head 65, motor driver 93, roll paper conveyance motor 83, and AC motor 84.

After one of the process units 201 and 202 of the media processing device 1 is selected as the control object to be controlled, power can be supplied from the power supply unit 95 to the selected process unit.

The host computer 5 can send a command for selecting either roll paper 3 or a check 4 as the process medium to be processed by the media processing device 1. This command is a command for selecting roll paper 3 or a check 4 as the process medium, and the media processing device 1 receives the command as a selection command changing the process medium to roll paper 3 or a check 4.

The media processing device 1 is configured to select the process unit 202 that processes roll paper 3 as the default process unit 201 and 202. For example, when the media processing device 1 power turns on, when the media processing device 1 is reset, and when the media processing device 1 wakes up from a sleep mode, roll paper 3 is selected as the process medium and process unit 202 is selected as the process unit. Roll paper 3 is thus selected automatically when the media processing device 1 is initialized.

The control command sent by the host computer 5 to the media processing device 1 after the roll paper 3 is selected automatically by initialization is also a selection command as described above.

This selection command may vary according to the process unit that is selected, or a plurality of commands could function as selection commands. For example, the selection commands that specify switching to the process unit 202 are not limited to commands that specify roll paper 3, and include control commands that tell the media processing device 1 to reset or to wake up from the sleep mode. Selection commands that switch from process unit 202 to process unit 201 are also not limited to commands that select checks 4, and include commands for cleaning or flushing the inkjet head 10 of the process unit 201, and commands from the host computer 5 requesting the status of parts of the process unit 201 from the media processing device 1.

When a selection command is received from the host computer 5, the CPU 101 changes the process unit to which power is supplied from the power supply unit 95 from process unit 201 to process unit 202, or from process unit 202 to process unit 201. In addition, when the media processing device 1 is processing roll paper 3 and a selection command to change the process medium to roll paper 3 is sent from the host computer 5 to the media processing device 1, for example, the media processing device 1 could receive the selection command, determine that there is no need to change the process unit, and ignore the command.

When a process that changes the process medium according to a selection command is executed, the process unit 201 or 202 that was selected must be initialized. More specifically, initialization is required the first time the selected process unit is operated after the power turns on, when a specific time has past since the selected process unit was initialized, when a specific time has past since the power turned on or the media processing device 1 woke from a sleep mode, and when an error occurs in the selected process unit, for example.

Initialization includes a process that determines if the mechanical parts of the process units 201 and 202 operate normally by causing the motors of the process units 201 and 202 to perform specific operations. For example, when process unit 202 is initialized, the CPU 101 controls the motor driver 93 to drive the roll paper conveyance motor 83, and determines if the roll paper conveyance motor 83 operates normally based on the output of a rotary encoder (not shown in the figure) that detects rotation of the roll paper conveyance motor 83, or by detecting the motor current while the motor is operating. When initializing process unit 202, the ASF motor 27 is also driven a specific amount to operate the hopper 25 and determine if the hopper 25 is operating normally based on the output of the hopper position detector 32. This initialization of the process units 201 and 202 is required before roll paper 3 or a check 4 is processed for the first time after the power turns on, and normal operation of the mechanical mechanisms is checked by this initialization process.

By determining if operation is normal by this initialization process, soiling the roll paper 3 or check 4, and more severe problems such as damage to the media processing device 1, can be avoided when there is a problem with either process unit 201 or 202.

The CPU 101 stores an initialization history for the initialized process unit in RAM 103 whenever process unit 201 or 202 is initialized. For example, a flag set to a specific value according to the initialization state is stored together with the date and time initialization occurred in RAM 103 for the initialized process unit. The date and time stored in RAM 103 is acquired from the real-time clock of the CPU 101, for example. The information stored in RAM 103 is cleared whenever the media processing device 1 power turns off.

When a motor that does not operate normally, for example, is detected during initialization, the CPU 101 determines that an error occurred.

When an error occurs in the process unit 201 or 202 that is not selected for control, the CPU 101 stores an error history in RAM 103 (storage unit). When the CPU 101 changes the process unit based on a command received from the host computer 5, and an error history is stored for the selected process unit in RAM 103, the CPU 101 initializes the selected process unit. When an error occurs in the process unit 201 or 202 selected for control, the error is immediately detected and the process unit goes off-line. However, when an error occurs in the process unit not being controlled, the error can be handled when the control object changes because an error history is stored in RAM 103, and whether or not the process unit selected by the command from the host computer 5 can be operated reliably can be quickly determined. Furthermore, because operation of the process unit being controlled is not interrupted when an error occurs in the process unit 201 or 202 not being controlled, the process being executed can be reliably completed.

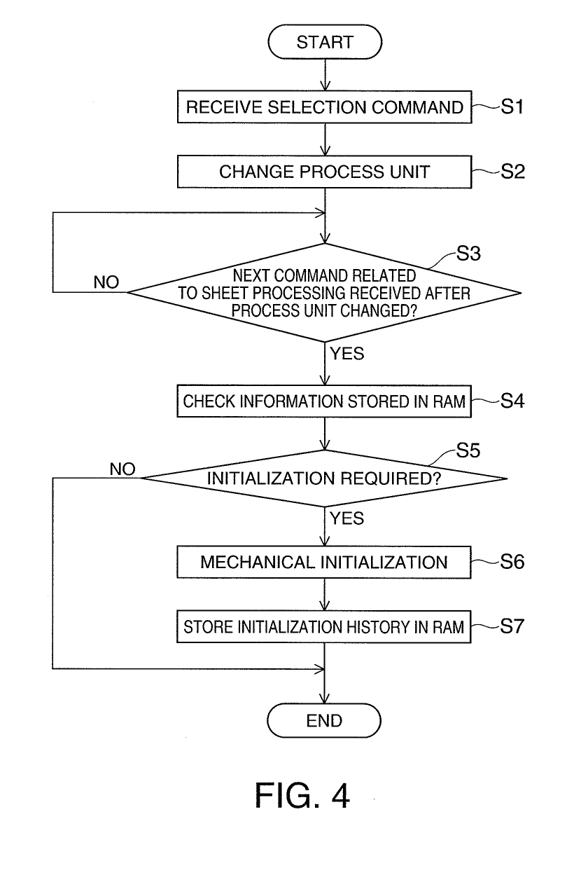

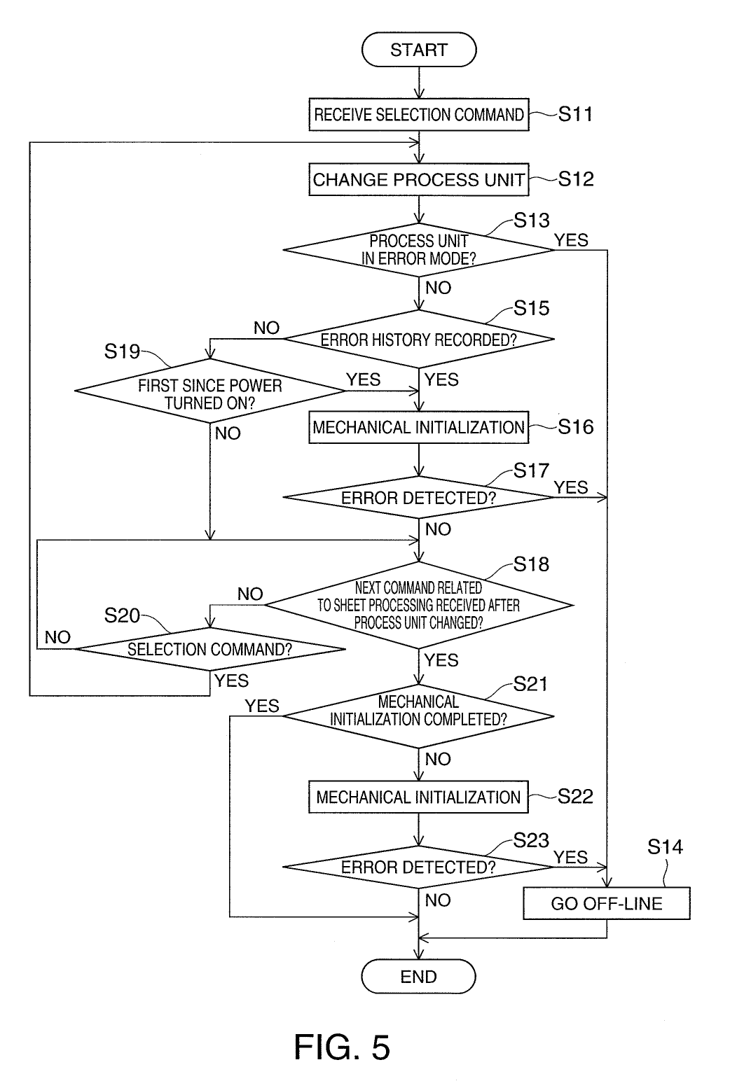

FIG. 4 is a flow chart of the operation of the media processing device 1, and more particularly describes the operation related to changing the process unit. The CPU 101 functions as a switching control unit when performing the operation shown in FIG. 4 and FIG. 5.

The CPU 101 receives a selection command for changing the process unit to operate from the host computer 5 (step S1), and executes a selection process related to selecting process unit 201 or 202 for control according to the received selection command (step S2).

In this selection process the CPU 101 executes a process that changes the control program to the program matching the selected process unit, and a process that changes the motor driver to which power is supplied from the power supply unit 95, that is, a process that connects the motor driver included in the selected process unit to the power supply unit 95. When the process unit is changed from process unit 202 to process unit 201, the FPGA 104 is also configured. Changing the controlled process unit from process unit 202 to process unit 201 is described in the following example.

In this example, process unit 202 is the first process unit in the accompanying claims, and process unit 201 is the second process unit. The controlled process unit can also be changed from process unit 201 to process unit 202, in which case process unit 201 is the first process unit and process unit 202 is the second process unit.

The CPU 101 then waits to receive a command related to the selected process unit 201, that is, to receive a command related to processing a check 4, which is the medium processed by the process unit 201 (step S3). When a check 4 processing command is received (step S3 returns Yes), the CPU 101 references the information stored in RAM 103 (step S4), and based on this information determines if initialization of the process unit 201 is required (step S5).

If an initialization history is stored for process unit 201 in RAM 103, the CPU 101 determines in step S5 that initialization is not required if the process unit 201 is already initialized, and determines that initialization is required if the process unit 201 was not initialized. If, for example, the date and time when the process unit 201 was initialized is stored in RAM 103, the CPU 101 determines how much time has past since initialization, and determines that initialization is required if the elapsed time exceeds a preset time. Further alternatively, if the time when the media processing device 1 woke from a sleep mode is stored in RAM 103, the CPU 101 determines that initialization is required if the time past since the media processing device 1 woke up exceeds a preset time. Further alternatively, information indicating the time past since the process unit 201 was initialized could be stored in RAM 103.

If the CPU 101 determines that initialization is required (step S5 returns Yes), the CPU 101 initializes the process unit 201 (step S6), stores the initialization history in RAM 103 (step S7), and ends the process. In step S7 the CPU 101 sets the flag stored in RAM 103 to a value indicating that initialization was completed, and stores the flag with the date and time of initialization in RAM 103.

The CPU 101 also ends the process if initializing the process unit 201 is determined unnecessary in step S6.

The CPU 101 then processes a check 4 according to the command received from the host computer 5 in step S3.

Because the process unit is not initialized when the process unit is changed according to a selection command and the selected process unit has already been initialized, the CPU 101 can suppress the number of times initialization is performed by not initializing the process units unnecessarily. The delay caused by switching the process unit can also be shortened by suppressing the number of times the process unit is initialized.

Furthermore, because initialization is done when a command related to the selected process unit is received after the selection command is received, and initialization is not triggered by simply receiving a selection command, the CPU 101 can eliminate unnecessary initialization when, for example, a command to switch to process unit 201 is received and a selection command to change to process unit 202 is then received before process unit 201 is actually used.

As a result, time waiting for initialization to end can be reduced. Process unit 201 also has an inkjet head 10, and consumables are spent by cleaning or flushing the inkjet head 10 during initialization. Consumables can therefore be saved by eliminating unnecessary initialization.

The CPU 101 can also appropriately determine if initialization is required by determining if initialization of the selected process unit is needed based on information stored in RAM 103. For example, when an initialization history is stored in RAM 103 as shown in FIG. 4, the need for initialization can be appropriately determined according to whether or not the process unit 201 was already initialized.

Based on information stored in RAM 103, the CPU 101 can also determine whether or not to initialize the process unit based on the time past since the process unit 201 was last initialized. For example, the process unit 201 preferably cleans or flushes the inkjet head 10 at a specific time interval based on the characteristics of the inkjet head 10. In this case, the need for initialization can be appropriately determined by determining if initialization is required based on the time past since the last initialization instead of based only on whether or not the process unit was initialized.

Because the thermal head 65 of process unit 202 does not require cleaning or flushing at a regular time interval, the CPU 101 can apply different conditions to determine if initialization is required for each process unit. More specifically, when process unit 201 is selected, the need for initialization is determined based on the time past since the last initialization based on the initialization history stored in RAM 103, but when process unit 202 is selected, the need for initialization is determined based only on whether or not the process unit 202 has been initialized. The need for initialization can thus be determined appropriately according to the characteristics of the individual process units 201 and 202.

FIG. 5 is a flow chart of media processing device 1 operation, and more particularly shows an operation related to changing the process unit. FIG. 5 shows an example in which the occurrence of an error in process unit 201 or 202 is considered when determining if initialization is required. The operation in FIG. 5 also describes changing from process unit 202 to process unit 201.

The CPU 101 receives a selection command for changing the process unit to operate from the host computer 5 (step S11), and executes a selection process related to selecting process unit 201 or 202 as the control object according to the received selection command (step S12). This selection process is the same as step S2 in FIG. 4.

The CPU 101 then determines if an error occurred in the process unit 201 (step S13). If an error occurred (step S13 returns Yes), the CPU 101 takes the media processing device 1 offline (step S14) and ends the process.

If an error has not occurred in the selected process unit 201 (step S13 returns No), the CPU 101 reads the error history stored in RAM 103 and determines if an error was recorded for the process unit 201 (step S15).

If an error history is found (step S15 returns Yes), the CPU 101 initializes the process unit 201 (step S16) and determines if an error occurred during initialization (step S17). An error history for the process unit 201 being stored in RAM 103 means that an error occurred in the process unit 201 while process unit 202 was the control object, and if the error is an unrecoverable error is detected by initialization.

The error history is read and initialization attempted when the selection command is received so that an error in the selected process unit 201 can be reported to the host computer 5 before a command related to the selected process unit 201 is received from the host computer 5. Errors can be reported by, for example, setting the media processing device 1 to an offline or busy state, or returning an error status report to the host computer 5. This enables quickly handling errors in the selected process unit 201 on the host computer 5 side when switching to control the process unit 201.

When an error occurs during initialization or after initialization (step S17 returns Yes), the CPU 101 goes to step S14 and goes offline. If an error did not occur in the process unit 201 (step S17 returns No), the CPU 101 waits until a command related to the selected process unit 201, that is, until a command related to processing a check 4 with the process unit 201, is received (step S18).

If an error history for the process unit 201 is not stored in RAM 103 (step S15 returns No), the CPU 101 determines if this is the first opportunity to control the process unit 201 since the media processing device 1 power turned on (step S19). If the process unit 201 is controlled for the first time since the media processing device 1 power turned on (step S19 returns Yes), the CPU 101 goes to step S16 and initializes the process unit 201. If the process unit 201 was previously controlled after the media processing device 1 power turned on (step S19 returns No), the CPU 101 goes to step S18 without initializing the process unit 201. The CPU 101 then stores a flag indicating that the process unit 201 was not initialized in RAM 103.

In step S18 the CPU 101 waits to receive a command from the host computer 5, and when a command is received, determines if the received command is a check 4 processing command. If the received command is not a check 4 processing command (step S18 returns No), the CPU 101 determines if the received command is a selection command (step S20), returns to step S12 if the command is a selection command (step S20 returns Yes), and starts the process to change the process unit 202 to be controlled. If the received command is not a selection command (step S20 returns No), the CPU 101 returns to step S18 without executing the command.

If the received command is a check 4 processing command (step S18 returns Yes), the CPU 101 determines (step S21) based on the flag stored in RAM 103 if the process unit 201 was initialized in step S16. If the process unit 201 has not been initialized since the selection command was received (step S21 returns No), the CPU 101 initializes the process unit 201 in the same way as in step S16 (step S22), and determines if an error occurred (step S23). When an error occurs during initialization or after initialization (step S23 returns Yes), the CPU 101 goes to step S14 and goes offline. If an error did not occur in the process unit 201 (step S23 returns No), the CPU 101 ends the process and processes the check 4 according to the command received from the host computer 5. If the CPU 101 determined the process unit 201 was initialized in step S21, the CPU 101 ends this process and processes the check 4 according to the command received from the host computer 5.

Note that the same operation described in FIG. 4 and FIG. 5 is performed when the controlled process unit is changed from process unit 201 to process unit 202.

As described above, a media processing device 1 according to this embodiment of the invention has a process unit 202 that performs an operation related to processing roll paper 3 as the process medium, a process unit 201 that performs an operation related to processing a check 4 as a medium different from roll paper 3, and a CPU 101 that changes the controlled process unit to process unit 201 according to a command specifying changing from process unit 202 to process unit 201, and executes control that does not initialize the process unit 201 when the process unit 201 has already been initialized, and can therefore eliminate unnecessary initialization as a result of control by the CPU 101. By suppressing the number of times the process units are initialized, the time waiting to change the process unit can also be shortened.

If the selected process unit 201 has not been initialized when a selection command is received, the CPU 101 initializes the process unit 201 when a command related to the process unit 201 is received. The time-consuming initialization operation therefore starts when a command related to the selected process unit 201 or 202 is additionally received after the selection command is received. Therefore, for example, if the host computer 5 sends a selection command to change the process unit, the CPU 101 accordingly changes the process unit to be controlled to process unit 201 or 202, and another selection command is then sent from the host computer 5 without a command related to the process unit 201 or 202 that was just selected being received from the host computer 5 and without the selected process unit being used, the unused process unit is not initialized. As a result, more time is not required to execute a selected process when a command related to the process unit selected by the second selection command is received. This also happens when the media processing device 1 power is turned off after the CPU 101 changes the process unit according to the selection command. Because the media processing device 1 according to this embodiment of the invention eliminates unnecessary initialization operations, the delay time accompanying initialization processes in the media processing device 1 can be reduced.

When the process unit 201 is initialized, consumables such as ink are spent by driving the inkjet head 10 and pump motor 82 to perform the cleaning operation at a preset frequency. However, by reducing the number of unnecessary initializations, ink consumption can be reduced. Roll paper 3 is consumed by driving the roll paper conveyance motor 83 when initializing the process unit 202, and paper consumption can likewise be reduced by reducing the number of unnecessary initializations.

These operations are also performed for the process unit 202 when a selection command that changes the control object from process unit 201 to process unit 202 is received.

Information related to the selected process unit 201 or 202 is stored in RAM 103, and the CPU 101 can reference the information related to the selected process unit 201 or 202 stored in RAM 103 to appropriately determine whether or not to initialize the process unit 201 or 202.

Furthermore, because the CPU 101 stores a record of having initialized the process unit 201 or 202 in RAM 103 whenever a process unit 201 or 202 is initialized, the CPU 101 can appropriately determine if initialization is needed based on this stored history.

The information related to the process units 201 and 202 stored in RAM 103 could also include the time past since the process unit 201 or 202 was initialized, or information for determining this elapsed time. In this case, the CPU 101 can appropriately determine whether to initialize the process unit 201 or 202 based on the elapsed time information stored in RAM 103.

The information related to the process units 201 and 202 stored in RAM 103 could also an error history that is stored when an error occurs in process unit 201. In this case, the CPU 101 can appropriately determine whether to initialize the process unit 201 based on the error history stored in RAM 103. Note that a nonvolatile RAM 103 device could be used so that the stored information is not cleared from memory when the media processing device 1 power turns off. The error history could also be stored in a nonvolatile memory device other than RAM 103.

Because the CPU 101 initializes the selected process unit to clear any errors when there is a record of an error in the selected process unit stored in RAM 103, the CPU 101 can quickly address errors that occurred in the process unit that is not being controlled by initializing that process unit when it is then selected for control.

The process units 201 and 202 have a mechanical mechanism or control circuit, and initialization is initialization of the mechanical mechanism or initialization of the control circuit. For example, the process units 201 and 202 include a mechanical mechanism or FPGA 104 or other control circuit, and the time spent waiting for initialization can be reduced because the time-consuming initialization operation is omitted when not necessary. For example, the time spent waiting for initialization can be reduced by only performing time-consuming initialization operations when necessary, including initialization of mechanical mechanisms such as cleaning the inkjet head 10, detecting if a check 4 is present, and conveying media to eliminate backlash in the mechanism transferring drive power from the motors to the conveyance rollers, and initialization of control circuits including clearing rewritable memory areas in RAM 103, copying settings from flash ROM 102 to RAM 103, and reading and writing circuit data for FPGA and other programmable logic circuits from ROM to the control circuits.

Furthermore, because the process units 201 and 202 also print to different types of process media, unnecessary consumption of consumables can also be avoided and the delay accompanying initialization can be reduced by reducing unnecessary initialization. For example, the initialization delay is particularly long when the inkjet head 10 is wiped or flushed during initialization of process unit 201, and this delay can be effectively shortened by eliminating unnecessary initializations.

A preferred embodiment of the invention is described above, and the invention is obviously not limited thereto. For example, the foregoing embodiment describes the host computer 5 sending a selection command for changing the control object to process unit 201 or 202, and the CPU 101 operating as shown in FIG. 4 when this selection command is received, but the invention is not so limited. For example, the selection command does not need to be a dedicated command. More specifically, the CPU 101 could determine if the command sent by the host computer 5 is a command related to a process executed by the process unit that is not being controlled, and based on the result of this decision perform the same operation as when a selection command is received.

An embodiment having process units 201 and 202 as the process units of the media processing device 1 is described above, but the invention is not so limited and configurations having more process units are obviously conceivable. In addition to process unit 201, process unit 202 could also have a control circuit such as FPGA 104.

At least some of the function units shown in the block diagram in FIG. 3 describe functional configurations, all function units do not need to be rendered as discrete hardware devices, and the functions of plural function units can be combined in a single hardware device, or a single function unit can be rendered using plural hardware devices, through the cooperation of software and hardware.

The program run by the CPU 101 that executes the operations described above is not limited to being stored in flash ROM 102, and may be stored on a removable recording medium, or downloadably stored on another device connected over a communication line, and the media processing device 1 could download and run the program from the other device. Other aspects of the configuration can also be changed as desired.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A media processing device comprising:
a first process unit that executes an operation related to processing a medium;
a second process unit that executes an operation related to processing the same medium or a different medium; and
a switching control unit that changes the control object to the second process unit according to a selection command instructing switching from the first process unit to the second process unit, and applies control to not initialize the second process unit if the second process unit was initialized.

2. The media processing device described in claim 1, wherein:
the switching control unit initializes the second process unit when a command related to the second process unit is received if the second process unit was not initialized when the selection command was received.

3. The media processing device described in claim 1, further comprising:
a storage unit that stores information related to the second process unit;
wherein the switching control unit determines whether or not to initialize the second process unit based on the information related to the second process unit stored in the storage unit.

4. The media processing device described in claim 3, wherein:
when the second process unit is initialized, the switching control unit stores a history of initializing the second process unit in the storage unit as the information related to the second process unit.

5. The media processing device described in claim 3, wherein:
the information related to the second process unit stored in the storage unit is the time elapsed since the second process unit was initialized; and
the switching control unit determines whether or not to initialize the second process unit based on the elapsed time stored in the storage unit.

6. The media processing device described in claim 3, wherein:
the information related to the second process unit stored in the storage unit is an error history that is stored when an error occurs in the second process unit; and
the switching control unit determines whether or not to initialize the second process unit based on the error history stored in the storage unit.

7. The media processing device described in claim 1, wherein:
the second process unit has a mechanical mechanism or a control circuit; and
initialization of the second process unit includes initialization of the mechanical mechanism or initialization of the control circuit.

8. The media processing device described in claim 1, wherein:
the first process unit is a print unit that prints on roll media; and
the second process unit is a reading unit that reads information recorded on sheet media.

9. A method of controlling a media processing device, comprising steps of:
receiving a selection command to change from a first process unit that executes an operation related to processing a medium to a second process unit that executes an operation related to processing the same medium or a different medium;
determining if the second process unit has been initialized when changing to the second process unit based on the received selection command; and
not initializing the second process unit based on the selection command if the second process unit was initialized.

10. The method of controlling a media processing device described in claim 9, further comprising a step of:
initializing the second process unit when a command related to the second process unit is received if the second process unit was not initialized when the selection command was received.

11. The method of controlling a media processing device described in claim 9, further comprising a step of:
determining whether or not the second process unit has been initialized based on information related to the second process unit stored in a storage unit when changing to the second process unit based on the received selection command.

12. The method of controlling a media processing device described in claim 11, further comprising a step of:
storing a history of initializing the second process unit in the storage unit as the information related to the second process unit when the second process unit is initialized.

13. The method of controlling a media processing device described in claim 11, further comprising a step of:
storing the time elapsed since the second process unit was initialized as the information related to the second process unit in the storage unit.

14. The method of controlling a media processing device described in claim 11, further comprising a step of:
storing an error history that is stored when an error occurs in the second process unit as the information related to the second process unit in the storage unit.
